(19) United States
(12) Patent Application Publication
(10) Pub. No.: US 2014/0351196 A1
(43) Pub. Date: Nov. 27, 2014

(54) METHODS AND SYSTEMS FOR USING CLUSTERING FOR SPLITTING TREE NODES IN CLASSIFICATION DECISION TREES

(71) Applicant: SAS Institute Inc., Cary, NC (US)

(72) Inventors: Xiangqian Hu, Cary, NC (US); Xunlei Wu, Cary, NC (US); Xiangxiang Meng, Morrisville, NC (US); Oliver Schabenberger, Cary, NC (US)

(73) Assignee: SAS Institute Inc., Cary, NC (US)

(21) Appl. No.: 14/284,222

(22) Filed: May 21, 2014

Related U.S. Application Data
(60) Provisional application No. 61/825,575, filed on May 21, 2013.

(51) Int. Cl. G06N 5/04; G06F 17/30

(52) U.S. Cl. CPC G06N 5/046; G06F 17/30327
USPC 706/52

(57) ABSTRACT

Systems and methods for determining an optimal splitting scheme for a node in a classification decision tree. A computing system may receive input data related to a decision tree to be generated from a data set. The input data identifies a target attribute of the data set and a set of candidate attributes of the data set to be used as nodes in the decision tree. The computing system may determine, using a clustering algorithm and the set of candidate attributes, a number of potential splitting schemes to be used to split a node in the decision tree. The computing system may calculate a splitting measurement for each of the plurality of potential splitting schemes. The computing system may select an optimal splitting scheme from the plurality of potential splitting schemes for each node in the decision tree based on the splitting measurement.

### CROSS-REFERENCE TO RELATED APPLICATIONS

The present disclosure claims priority to U.S. Provisional Application No. 61/825,575, filed May 21, 2013 and titled “Methods and Systems for Clustering in Splitting Tree Nodes in Decision Trees,” the entirety of which is incorporated herein by reference.

### TECHNICAL FIELD

The present disclosure generally relates to computer-implemented systems and methods for generating decision trees.

### BACKGROUND

Decision trees are used as predictive models in statistical analysis, data mining, and machine learning. Current techniques for generating decision trees, however, utilize exhaustive enumeration approaches for determining branching schemes that can be computationally expensive.

### SUMMARY

In accordance with the teachings provided herein, systems and methods for data reduction in distributed data environments are provided.

For example, a computer-program product tangibly embodied in a non-transitory machine-readable storage medium is provided that includes instructions that can cause a data processing apparatus to receive input data related to a decision tree to be generated from a data set. The input data identifies a target attribute of the data set and a set of candidate attributes of the data set to be used as nodes in the decision tree. The computer-program product further includes instructions that can cause the data processing apparatus to determine, using a clustering algorithm and the set of candidate attributes, a number of potential splitting schemes to be used to split a node in the decision tree. The computer-program product further includes instructions that can cause the data processing apparatus to calculate a splitting measurement for each of the plurality of potential splitting schemes. The computer-program product further includes instructions that can cause the data processing apparatus to select an optimal splitting scheme from the plurality of potential splitting schemes for each node in the decision tree based on the splitting measurement.

In another example, a computer-implemented method is provided that includes receiving, by a computer device, input data related to a decision tree to be generated from a data set. The input data identifies a target attribute of the data set and a set of candidate attributes of the data set to be used as nodes in the decision tree. The method further includes determining, by the computer device, using a clustering algorithm and the set of candidate attributes, a plurality of potential splitting schemes to be used to split a node in the decision tree. The method further includes calculating, by the computer device, a splitting measurement for each of the plurality of potential splitting schemes. The method further includes selecting an optimal splitting scheme from the plurality of potential splitting schemes for each node in the decision tree based on the splitting measurement.

In another example, a system is provided that includes a processor and a non-transitory computer readable storage medium containing instructions that, when executed on the processor, cause the processor to perform operations. The operations include receiving, by a computer device, input data related to a decision tree to be generated from a data set. The input data identifies a target attribute of the data set and a set of candidate attributes of the data set to be used as nodes in the decision tree. The operations further include determining, by the computer device, using a clustering algorithm and the set of candidate attributes, a plurality of potential splitting schemes to be used to split a node in the decision tree. The operations further include calculating, by the computer device, a splitting measurement for each of the plurality of potential splitting schemes. The operations further include selecting an optimal splitting scheme from the plurality of potential splitting schemes for each node in the decision tree based on the splitting measurement.

### BRIEF DESCRIPTION OF THE DRAWINGS

The patent or application file contains at least one drawing executed in color. Copies of this patent or patent application publication with color drawings will be provided by the office upon request and payment of any necessary fee.

FIG. 1 illustrates a block diagram of an example of a compute implemented environment for determining an optimal splitting scheme for a node in a decision tree using a clustering algorithm that analyzes data sets,

FIG. 2 illustrates a block diagram of an example of a processing system of FIG. 1 for determining an optimal splitting scheme for a node in a decision tree using a clustering algorithm that analyzes a data set.

FIG. 3 illustrates an example of a flow diagram for determining an optimal splitting scheme for a node in a decision tree using a clustering algorithm that analyzes a data set.

FIG. 4 illustrates another example of a flow diagram for determining an optimal splitting scheme for a node in a decision tree using a clustering algorithm that analyzes a data set.

FIG. 5 illustrates an example of pseudo-code included in a node-splitting engine used to determine an optimal splitting scheme for a node in a decision tree using a clustering algorithm.

FIG. 6 illustrates an example of a data set used to determine a decision tree.

FIG. 7 illustrates examples of calculation results for a three-level decision tree built using a node-splitting engine discussed herein.

FIG. 8 illustrates examples of calculation results for a three-level decision tree built using an exhaustive enumeration algorithm.

FIG. 9 illustrates examples of calculation results for a three-level decision tree built using an ordered splitting algorithm.

FIG. 10 illustrates examples of calculation results for a three-level decision tree built using a node-splitting engine, discussed herein, on a data set having high cardinality.

FIG. 11 illustrates examples of calculation results for a three-level decision tree built using an exhaustive enumeration algorithm on a data set having high cardinality.

FIG. 12 illustrates examples of calculation results for a three-level decision tree built using an ordered splitting algorithm on a data set having high cardinality.

Like reference numbers and designations in the various drawings indicate like elements.

### DETAILED DESCRIPTION

Aspects of the disclosed subject matter relate to techniques for using a clustering algorithm, for example, a k-means algorithm, to determine a splitting scheme for a node in a classification decision tree, hereinafter “decision tree.” A “splitting scheme” for a node can identify a number of branches to split from a node and an arrangement of branches to be split from the node. The clustering algorithm can be used to analyze each candidate attribute in a data set to determine an optimal splitting scheme between the candidate attributes. The disclosed subject matter can be used and implemented in various computer systems, such as in visual analytics, visual statistics, and high-performance computing systems, tools, products, and solutions.

Clustering data mining analyses can be useful for solving many problems experienced while generating decision trees. However, existing splitting methods to generate decision trees either exhaustively enumerate all of the splitting options or split on sorted input variable values. The computation cost of exhaustive enumeration approaches may become prohibitive when the distinct count of variable values grow and when the data set is distributed. On the other hand, sorting large amounts of data, especially distributed data, can also be costly. In some cases, sorting may be required at every split in a decision tree. Besides the high computational cost, the induced ordering can produce less flexible groupings that can affect the decision tree accuracy.

In a branching algorithm, clustering algorithms may be used to determine the optimal splitting of a candidate attribute. The ordering of the values of the attribute may not be required for the split. The computational cost of exhaustive enumeration approaches can be reduced. Though a k-means clustering algorithm is used in examples, the branching algorithm can be used in any decision tree algorithm, as well as with any clustering technique (e.g., hierarchical clustering).

In one example, an optimal splitting scheme can be determined for a node in a decision tree using a clustering algorithm. A target attribute may be determined or received. As used herein, a “target attribute” is a set of values that are used as leaf nodes in a decision tree. A target attribute can be designated as the output of a decision tree. The data set may contain one or more candidate attributes. As used herein, a set of “candidate attributes” is a set of values to be used as decision nodes in the decision tree. A target attribute and a set of candidate attributes may be received from user input. Alternatively, the target attribute and the set of candidate attributes can be obtained from an alternate source. A clustering algorithm may be used to analyze each candidate attribute to determine a potential splitting scheme if the candidate attribute is to be used for a particular decision tree node. Each potential splitting scheme can be scored according to a standard statistical measurement. Standard statistical measurements include, but are not limited to, entropy functions, Gini indexes, information gains, and information gain ratios. The highest scored splitting scheme can be selected as an optimal splitting scheme and can be used to split the decision node.

Though the above examples utilize a distributed environment, a non-distributed computing environment in which a single computing node has a view of the entire data set can also benefit from the splitting algorithm described herein.

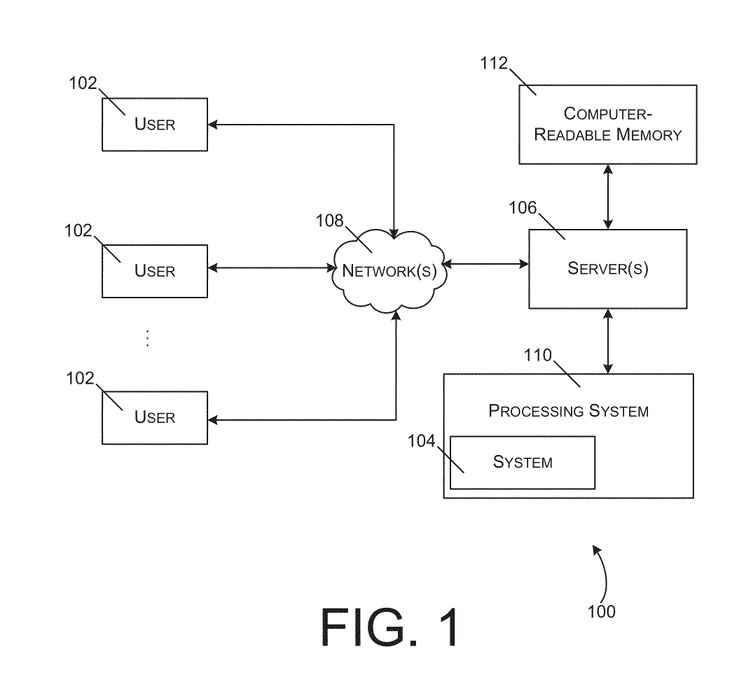

FIG. 1 illustrates a block diagram of an example of a computer-implemented environment 100 for determining an optimal splitting scheme for a node in a decision tree using a clustering algorithm that analyzes a data set. Users 102 can interact with a system 104 hosted on one or more servers 106 through one or more networks 108. The system 104 can contain software operations or routines. The users 102 can interact with the system 104 through a number of ways, such as over networks 108. Servers 106, accessible through the networks 108, can host system 104. The system 104 can also be provided on a stand-alone computer for access by a user.

In one example, the environment 100 may include a stand-alone computer architecture where a processing system 110 (e.g., one or more computer processors) includes the system 104 being executed on it. The processing system 110 has access to a computer-readable memory 112.

In one example, the environment 100 may include a client-server architecture. Users 102 may utilize a PC to access servers 106 running a system 104 on a processing system 110 via networks 108. The servers 106 may access a computer-readable memory 112.

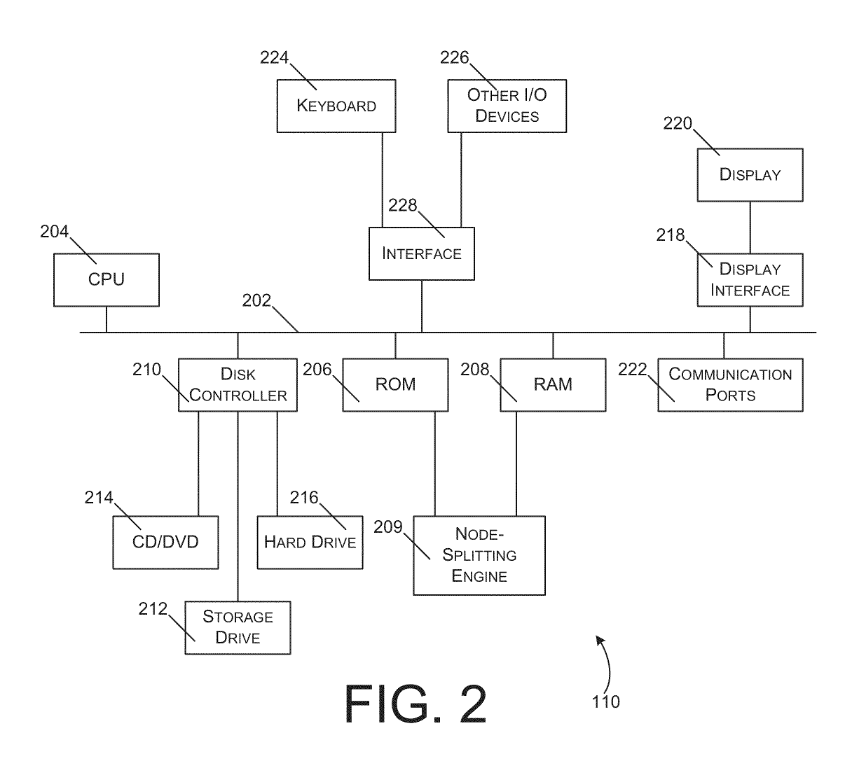

FIG. 2 illustrates a block diagram of an example of a processing system 110 of FIG. 1 for determining an optimal splitting scheme for a node in a decision tree using a clustering algorithm that analyzes a data set. A bus 202 may interconnect the other illustrated components of processing system 110. Central processing unit (CPU) 204 (e.g., one or more computer processors) may perform calculations and logic operations used to execute a program. A processor-readable storage medium, such as read-only memory (ROM) 206 and random access memory (RAM) 208, may be in communication with the CPU 204 and may contain one or more programming instructions. Optionally, program instructions may be stored on a computer-readable storage medium, such as a magnetic disk, optical disk, recordable memory device, flash memory, or other physical storage medium. Computer instructions may also be communicated via a communications transmission, data stream, or a modulated carrier wave. In one example, program instructions implementing node-splitting engine 209, as described further in this description, may be stored on storage drive 212, hard drive 216, read only memory (ROM) 206, random access memory (RAM) 208, or may exist as a stand-alone service external to the stand-alone computer architecture.

A disk controller 210 can interface one or more optional disk drives to the bus 202. These disk drives may be external or internal floppy disk drives such as storage drive 212, external or internal CD-ROM, CD-R, CD-RW, or DVD drives 214, or external or internal hard drive 216. As indicated previously, these various disk drives and disk controllers are optional devices.

A display interface 218 may permit information from the bus 202 to be displayed on a display 220 in audio, graphic, or alphanumeric format. Communication with external devices may optionally occur using various communication ports 222. In addition to the standard computer-type components, the hardware may also include data input devices, such as a keyboard 224, or other input/output devices 226, such as a microphone, remote control, touchpad, keypad, stylus, motion, or gesture sensor, location sensor, still or video camera, pointer, mouse or joystick, which can obtain information from bus 202 via interface 228.

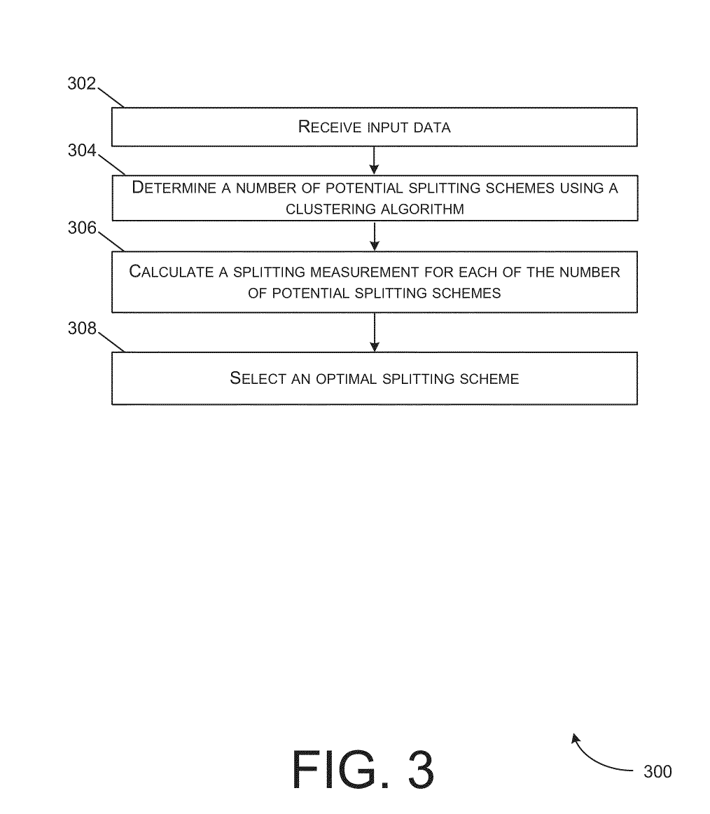

FIG. 3 illustrates an example of a flow diagram 300 for determining an optimal splitting scheme for a node in a decision tree as determined by a node-splitting engine (e.g., node-splitting engine 209). The flow diagram can begin at block 302 where node-splitting engine 209 may receive input data. The input data may include a target attribute of a data set and a set of candidate variables of the data set. The input data may further include a maximum number of branches to be allowed at the node. Alternatively, a default maximum number of branches may be used. The target attribute and each of the candidate attributes may exist in a same data set or in different data sets.

At block 304, node-splitting engine 209 determines a number of potential splitting schemes. In one example, each of the candidate attributes in the set of candidate attributes is analyzed using a clustering algorithm. The clustering algorithm may be a k-means clustering algorithm or any other algorithm used to cluster data points in a data set. The maximum number of branches to be allowed from each node may be identified in input data or, alternatively, determined from a default value. The node-splitting engine 209 may use the clustering algorithm to determine multiple splitting schemes for an individual candidate. For example, suppose the maximum branches to be allowed is equal to four. The node-splitting engine 209 may use the clustering algorithm and the maximum number of branches to determine a clustering solution containing two clusters, a clustering solution containing three clusters, and a clustering solution containing four clusters. The clusters resulting from the clustering analysis of the data set can correspond to the number and arrangement of the branches split from the node, in other words, a splitting scheme. A cluster analysis that results in three clusters will produce three branches split from the node. The maximum number of branches can be used to limit the clustering algorithm to a maximum number of clusters. At block 306, node-splitting engine 209 calculates a splitting measurement for each of the potential splitting schemes. A “splitting measurement” refers to a criterion used to measure an amount of information gain achieved if a particular splitting scheme is applied to a node in a decision tree. A splitting measurement may include, but is not limited to, an entropy function, a Gini impurity index, information gain, or an information gain ratio. Any splitting measurement may be used and would be apparent to one skilled in the art.

Assuming that a candidate attribute v, is considered to split an internal node L of the decision tree, the splitting measurement fᵢⱼ^{v} is the percentage of observations for which the target attribute t takes on decision tree level j and the candidate attribute v takes on decision tree level i. It can be computed as:

$${f}_{ij}^{v} = \frac{{N}_{obs} ( v = i , t = j )}{{N}_{obs}}$$

where N_{obs} is the total number of observations at the node L and N_{obs}(v=i,t=j) is the number of observations at the same node whose target attribute t equals j and the input attribute v equals i. Assume that the target attribute t has m levels. As such, the set fᵢ^{v}≡{fᵢⱼ^{v} for all j} constructs a point in space R^{m}. These points, one for each level of v, can be clustered to the desired number of clusters based on any standard clustering algorithm. The clusters may be used to define the splitting scheme of node L. The levels of v clustered into the same cluster fall in the same branch of the node L.

At block 308, node-splitting engine 209 selects an optimal splitting scheme from the potential splitting schemes determined at block 304. The selected optimal splitting scheme may correspond to the splitting scheme having the highest splitting measurement as calculated in block 306.

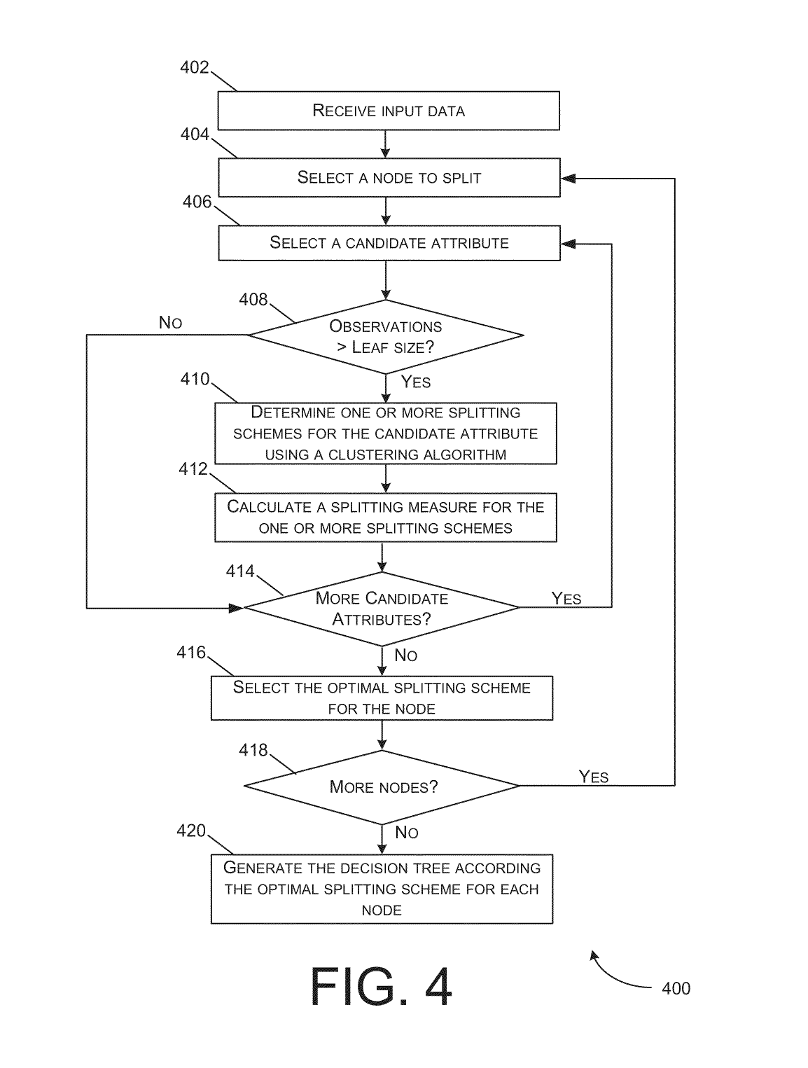

FIG. 4 illustrates another example of a flow diagram 400 for determining an optimal splitting scheme for a node in a decision tree as determined by a node-splitting engine (e.g., node-splitting engine 209). The flow diagram can begin at block 402 where node-splitting engine 209 may receive input data. As discussed above, the input data may include a target attribute and a set of candidate variables of the data set. The input data may further include a maximum number of branches to be allowed at the node. Alternatively, a default maximum number of branches may be used. At block 404, a selection may be made of a node to split. For example, the node may be a root node or any other decision node of a decision tree. Suppose, for the purposes of illustration, that a root node of the decision tree is selected.

At block 406, a candidate attribute may be selected. The candidate attribute belongs to the set of candidate attributes. The set of candidate attributes may be included in a vector. Selection of a first candidate attribute may correspond to selecting a first candidate in the vector. Similarly, an array or any appropriate data container can be used.

At decision block 408, node-splitting engine 209 determines whether the selected candidate attribute has more than a minimum number of observations (e.g., leaf size). An “observation,” as used herein, means a value of a particular candidate attribute. For example, the node-splitting engine 209 may require that a candidate attribute have 15 observations or more to be considered as a potential candidate for a node. One skilled in the art will appreciate that 15 observations are used for illustration only, and that any number of observations may be used as a threshold. If the candidate attribute does not have the required minimum number of observations, a determination may be made at decision block 414 as to whether more candidate attributes are available. If there are, then a new candidate may be selected at block 406. If there are not, then the flow may continue at block 416. If the candidate attribute has the minimum number of observations needed (e.g., at least 15) then the flow may proceed to block 410.

At block 410, node-splitting engine 209 determines one or more splitting schemes for the candidate attribute using a clustering algorithm. For example, suppose a maximum number of branches is included in the input data, and that the maximum number of branches is equal to four. Alternatively, the maximum number of branches may be defaulted to any value (e.g., four). At block 410, the node-splitting engine 209 may use a clustering algorithm configured to determine an optimal branching of the candidate attribute using two clusters. The node-splitting engine 209 also determines, using the clustering algorithm, an optimal branching of the candidate attribute for three clusters, and four clusters, respectively. In general, the node-splitting engine 209 may cause a clustering analysis to be conducted on the candidate attribute with a number of clusters designated up to, and including, the value of the maximum number of branches.

At block 412, node-splitting engine 209 calculates a splitting measurement for each of the one or more splitting schemes determined at block 410. The splitting measurement may indicate a level of statistical dispersion. The splitting scheme with the highest splitting measurement may be selected as the optimal splitting scheme for the candidate attribute.

At decision block 414, node-splitting engine 209 will determine if there are further candidate attributes. If there are more candidate attributes, the flow may repeat blocks 406 to 414 for each candidate attribute. If no more candidate attributes exist, then the flow may continue to block 416.

At block 416, node-splitting engine 209 selects the optimal splitting scheme for the node. For example, assume that five splitting schemes were determined by node-splitting engine 209, each splitting scheme corresponding to a particular candidate attribute, each splitting scheme having two or more branches. Node-splitting engine 209 may select an opt mal splitting scheme for the node by comparing the splitting measurement of each splitting scheme and selecting the splitting scheme with the highest splitting measurement. The candidate attribute corresponding to the selected splitting scheme can be selected for the node, and the selected splitting scheme can be used to split the node.

At decision block 418, node-splitting engine 209, may determine whether there are more nodes in the decision tree to split. If there are more nodes to split, blocks 404 through 418 may be repeated for each node. If there are no further nodes to split, the flow y continue at block 420 where node-splitting engine 209 can generate the decision tree according to the selected optimal splitting scheme for each node determined at block 416. Alternatively, the node-splitting engine 209 can generate a portion of the decision tree at each iteration of block 416.

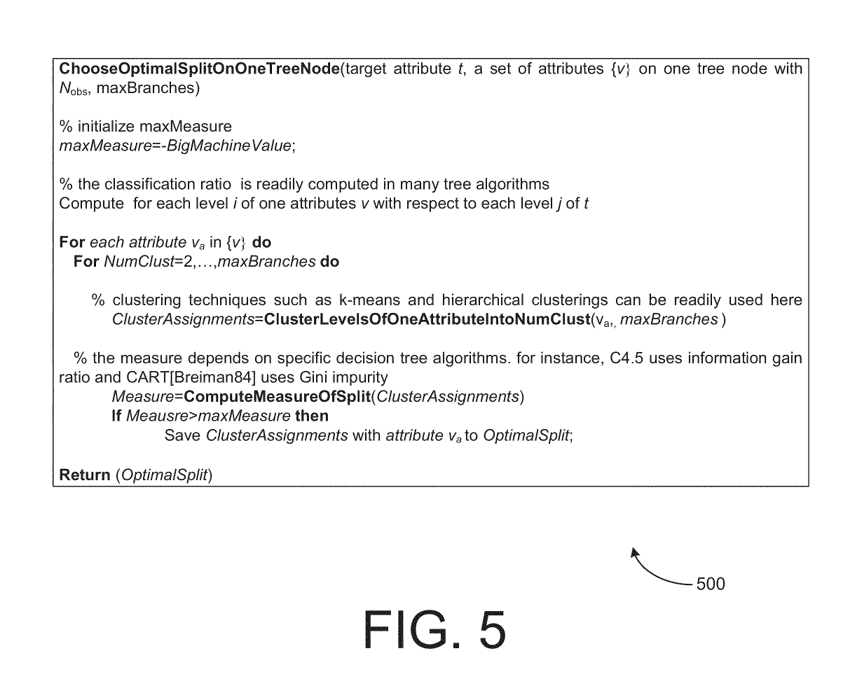

FIG. 5 illustrates an example of pseudo-code 500 included in a node-splitting engine (e.g., node-splitting engine 209) used to determine an optimal splitting scheme for a node in a decision tree using a clustering algorithm as described in FIG. 4. It should be appreciated that the pseudo-code illustrated in FIG. 5 is illustrative in nature and is not intended to illustrate every aspect of implementing source code. FIG. 5 illustrates a function call ChooseOptimalSplitOnOneTreeNode that includes three parameters: t, {v}, and maxBranches, where t is the target attribute, {v} is a set of candidate attributes for nodes of the decision tree, and maxBranches indicates a maximum number of branches to allow at a given node.

Pseudo-code 500 includes an initialization of variable maxMeasure. Subsequently, ChooseOptimalSplitOnOneTreeNode causes a number of clustering assignments to be decided. For example, assume that maxBranches=4, multiple cluster assignment combinations will be determined for each candidate attribute in {v} using a number of clusters starting at two and ending at four. The cluster assignments may be determined by using a clustering algorithm. In this example, ClusterLevelsOfOneAttributeIntoNumCluster may cause a clustering algorithm to be executed using the candidate attribute and maxBranches. Thus, for candidate attribute v₁ of {v}, multiple cluster assignments will be determined including a cluster assignment using two clusters, as well as cluster assignment using three clusters, as well as cluster assignment using four clusters. The cluster assignments in this example correspond to the splitting schemes discussed in connection with FIG. 4. The number of clusters and cluster assignments correlate to a number of branches and an arrangement of the branches to be split from a node, otherwise referred to herein as a splitting scheme.

Pseudo-code 500 illustrates that each splitting scheme for each candidate variable will be assigned a splitting measurement determined by a function call ComputeMeasureOfSplit. The splitting measurement, as discussed above, refers to a criterion used to measure an amount of importance of the candidate attribute. The highest splitting measurement will be saved as the optimal split for the candidate attribute.

Once a splitting scheme is determined for candidate attribute v₁, node-splitting engine 209 will continue to determine splitting schemes for each candidate attribute in {V} (e.g., via ClusterLevelsOfOneAttributetoNumClust( )). Each splitting scheme will be used to calculate a splitting measurement and each candidate attribute will have an optimal splitting scheme. Once each candidate attribute has an optimal splitting scheme, the ChooseOptimalSplitOnOneTreeNode algorithm may measure each of the optimal splitting schemes for the candidate attributes and select a highest optimal splitting scheme to be used as the splitting scheme for the node. Alternatively, the ChooseOptimalSplitOnOneTreeNode algorithm may use splitting measurements already calculated to determine an optimal splitting scheme for the candidate attribute when determining the optimal splitting scheme for the node.

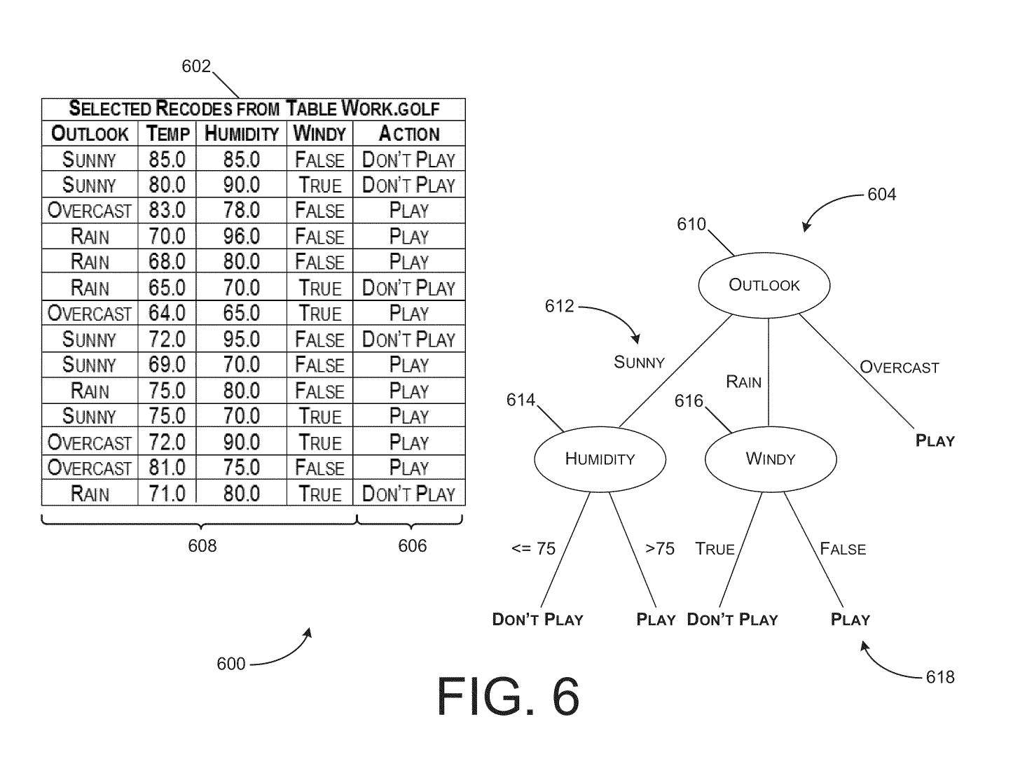

FIG. 6 illustrates an example of a data set 602. Using the data set 602 as an example, decision tree 604 can be generated using the node-splitting engine 209. Consider that the target attribute 606 is designated as “action” and the set of candidate attributes 608 includes “outlook,” “temp,” “humidity,” and “windy.” A node 610 may be selected using the process discussed in connection with FIG. 4. Consider that the candidate attribute “outlook” is first selected. According to the process discussed in FIG. 6, two or more splitting schemes can be determined for “outlook.” Similarly, splitting schemes for the remaining candidates in the set of candidate attributes 608 may be determined. Consider that splitting scheme 612, having been scored higher than any other splitting scheme for the set of candidate attributes 608, indicates that the optimal splitting scheme is to use “outlook” as the candidate attribute of node 610, with branches “sunny,” “rain,” and “overcast” as depicted by splitting scheme 612. Once selected, a candidate attribute can be removed from the set of candidate attributes. Optimal branching schemes for nodes 614 and 616 may be similarly determined using the process described above. In this matter, decision 618 may be determined using the set of candidate attributes 608.

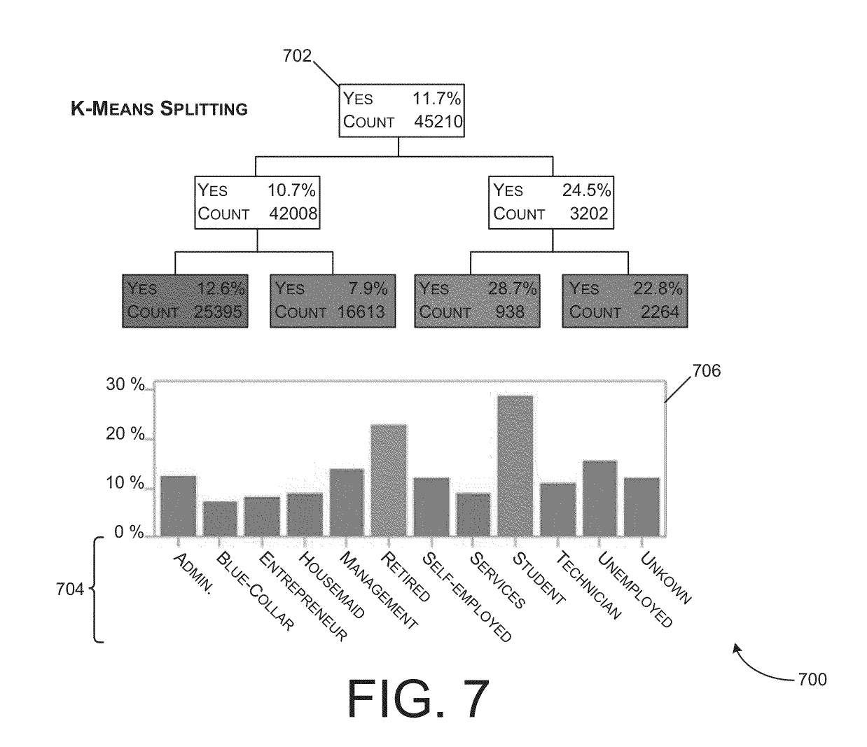

FIGS. 7-9 illustrate calculation results for a three-level decision tree built using the various splitting methods. In FIGS. 7-9 the decision tree is built on a marketing data set with a target attribute (e.g., “Subscription”) having values of either “Yes” or “No”, and various candidate attributes 704, 804, and 904 (e.g., “Job” candidates) as the respective sets of candidate attributes. For each splitting algorithm, a bar plot of the percentages of target event (e.g., Subscription=Yes) for each level of the candidate attribute. Levels with the same color in the bar plot are partitioned into the same leaf of the corresponding decision tree. More specifically, the bar plot shows the partitioning of a “Job” level into the four leaves of the decision tree, where each color represents a leaf in the tree structure. Thus, the colors in each graph correspond to individual clusters determined by the clustering algorithm.

FIG. 7 illustrates examples of calculation results for a three-level decision tree 702 bunt using a node-splitting engine 209 discussed herein.

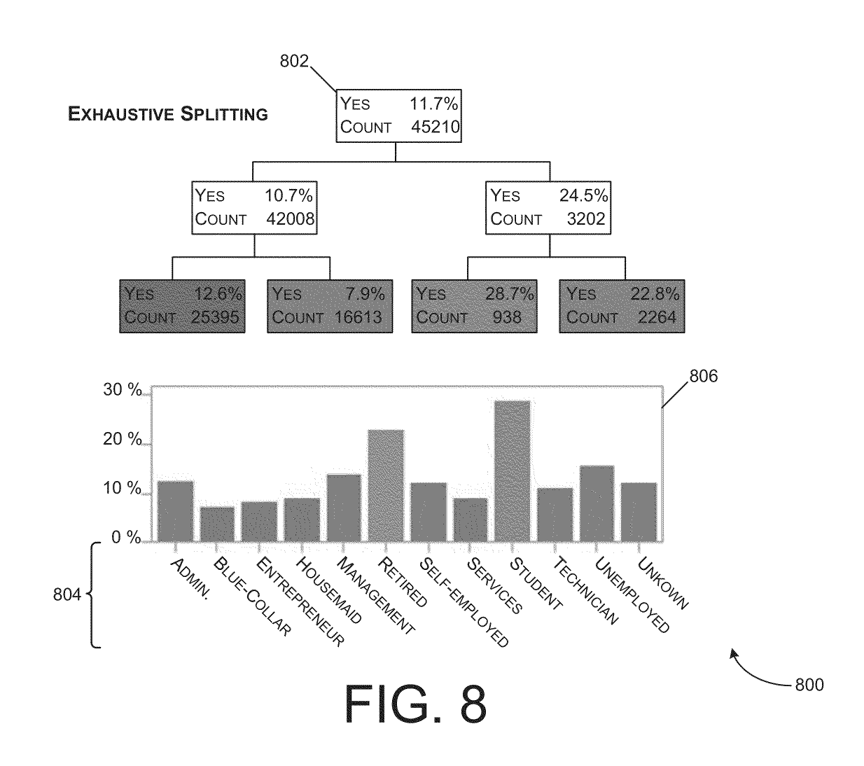

FIG. 8 illustrates examples of calculation results for a three-level decision tree 802 built using a splitting method that exhaustively enumerates all possible groupings of the levels of the candidate variables.

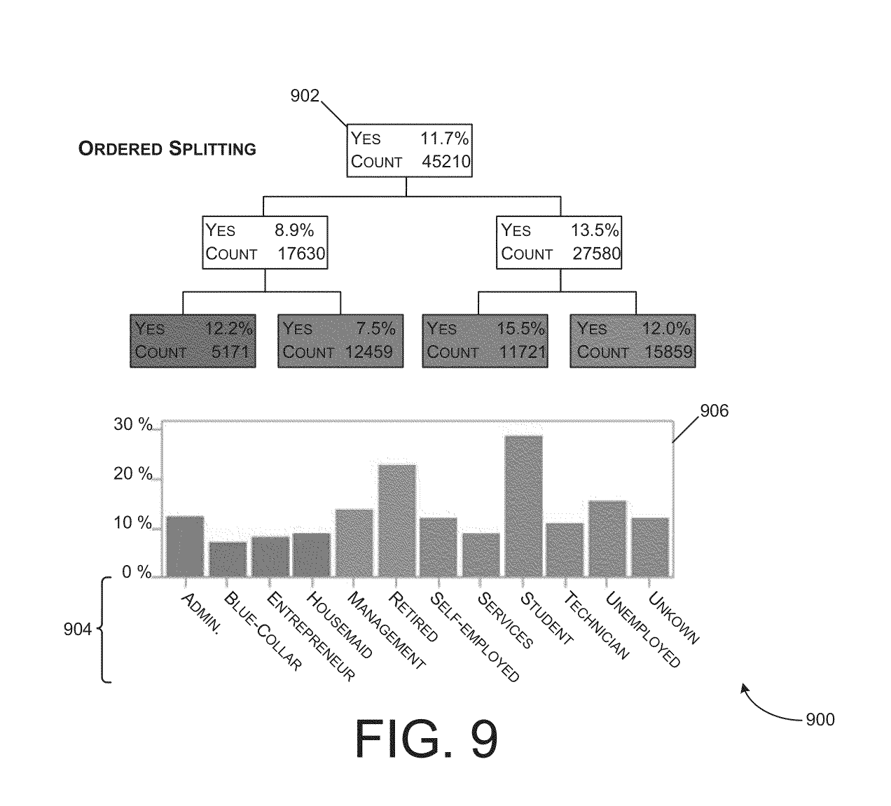

FIG. 9 illustrates examples of calculation results for a three-level decision tree 902 bunt using a splitting method that uses a sorted order of the levels of the candidate attribute.

FIGS. 7-9 illustrate that a k-means algorithm and an exhaustive searching algorithm identify the same segmentations. In contrast, an ordered splitting algorithm does not result in a reasonable segmentation. An ordering splitting algorithm requires that the data set be ordered according to candidate attribute values prior to analyzing. For example, the “student” level, which has the highest percentages of target events, is grouped with some other levels with much lower target event percentages. This suggests that the ordered splitting algorithm is inappropriate to split the tree node.

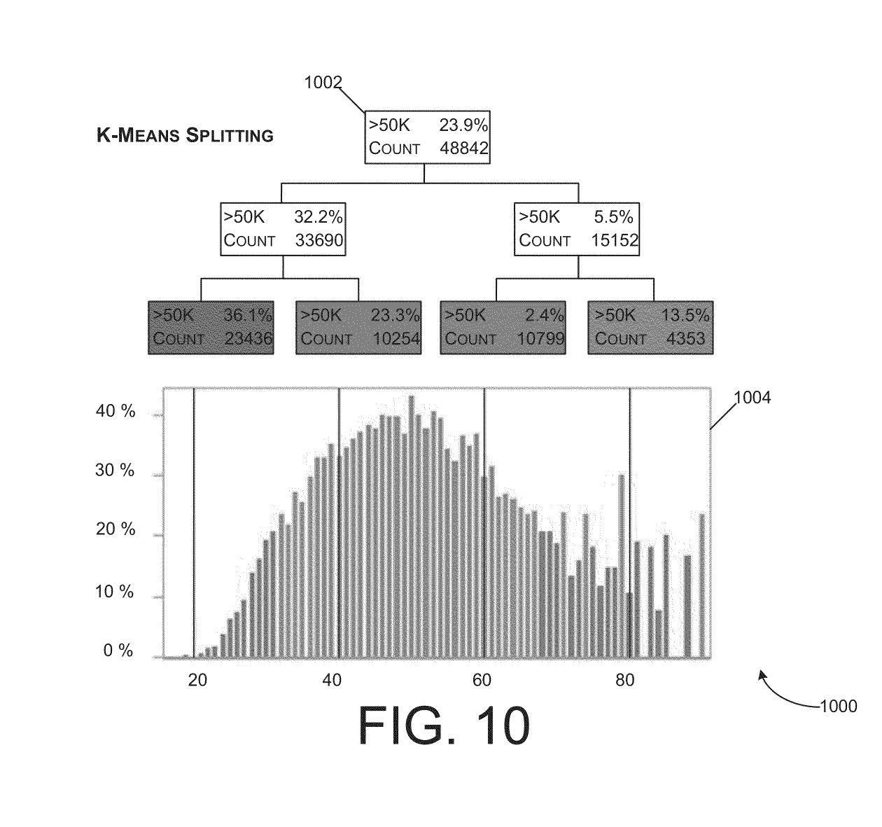

FIGS. 10-12 illustrate examples of calculation results for a three-level decision tree built using the various splitting methods on a data set with high-cardinality. In FIGS. 10-12 the decision tree is built on an “Adult” data set with a target attribute (e.g., “Salary”) having values of either “>$50,000” or “<=$50,000”, and a candidate attribute “Age.” For each splitting algorithm, a bar plot of the percentages of target event (e.g., target attribute=“>$50,000”) for each level of the candidate attribute “Age.” Levels with the same color in the bar plot are partitioned into the same leaf of the corresponding decision tree. In other words, the bar plot shows the partitioning of an “AGE” level into the four eaves of the decision tree, where each color represents a leaf in the tree structure.

FIG. 10 illustrates examples of calculation results for a three-level decision tree 1002 built using a node-splitting engine 209 discussed herein on a data set having high cardinality.

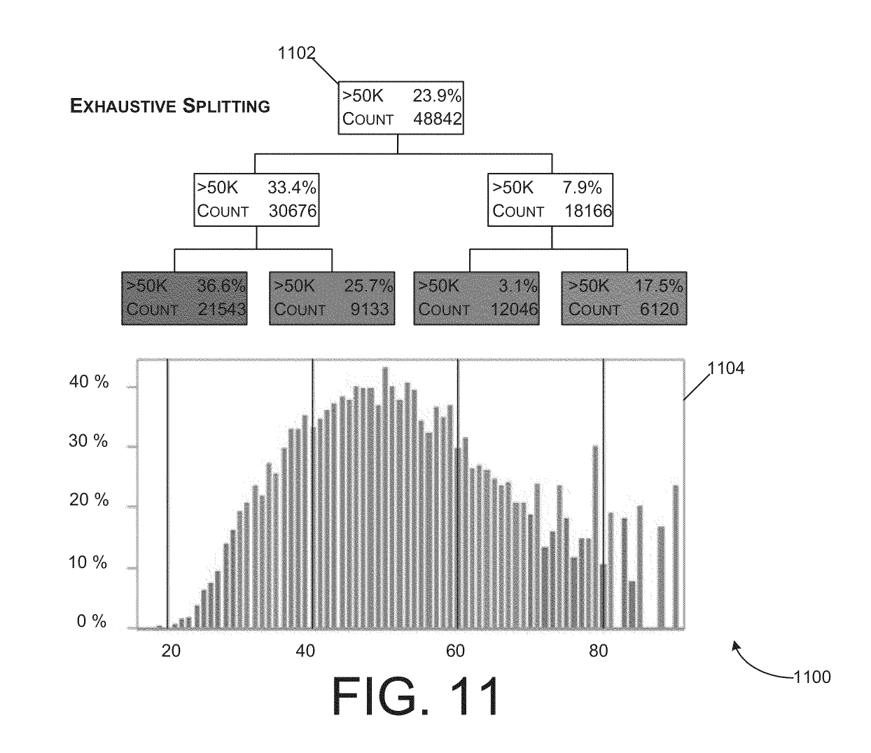

FIG. 11 illustrates examples of calculation results for a three-level decision tree 1102 built using the splitting method that exhaustively enumerates, on a data set having high cardinality, all possible groupings of the levels of the candidate variable.

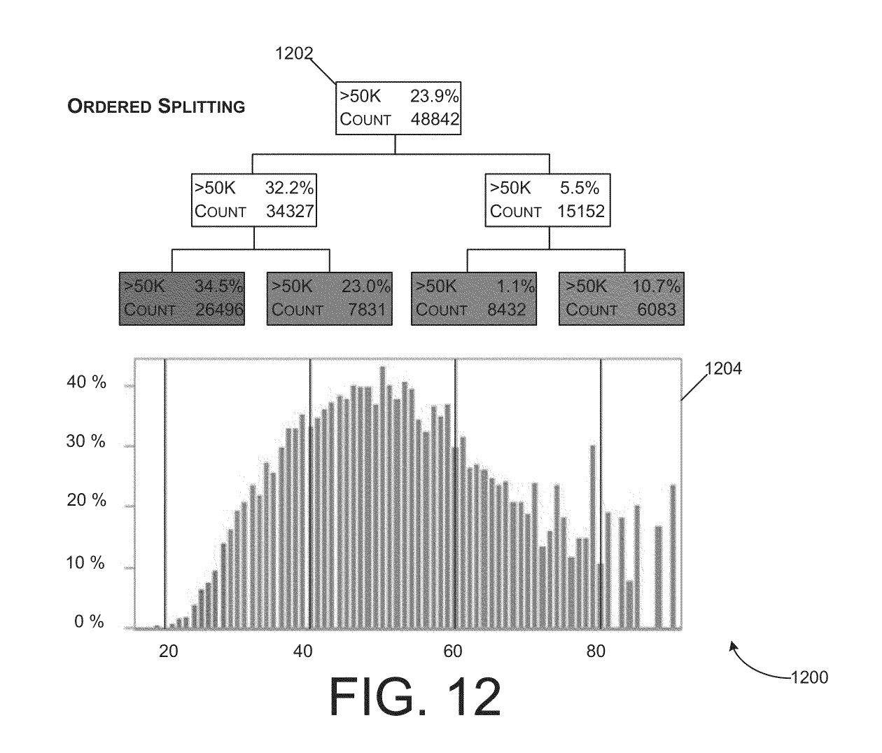

FIG. 12 illustrates examples of calculation results for a three-level decision tree 1202 built using a splitting method that uses a sorted order of the levels of the candidate attribute on a data set having high cardinality.

FIGS. 10-12 illustrate that a splitting scheme determined using a k-means algorithm and a splitting scheme determined using an exhaustive searching algorithm produce very similar level segmentations, while the major differences appear mainly in the right tail (Age>75). Again, splitting schemes determined with an ordered splitting algorithm results in much worse partitioning given that the ordered splitting algorithm cannot separate out the peak (35<age<60) and the right tail (Age>75) of the target event distribution as shown in FIG. 12. Since exhaustive enumeration is not applicable when one attribute has high cardinality, a splitting scheme determined using a clustering algorithm is robust and efficient.

Overall, FIGS. 7-12 illustrate that a splitting scheme determined using a clustering algorithm, as disclosed herein, is computationally inexpensive, is easily adopted for large-scale distributed data sets, and is capable of identifying decision tree structures (i.e. the data segmentation by the leaves) that are similar to the global optimal splitting obtained by exhaustively searching over all possible splits of the candidate attribute levels. FIGS. 7-12 also illustrate that the splitting algorithm using a k-means clustering algorithm can obtain better data segmentations than the ordered splitting algorithm. Thus, the clustering-based splitting algorithm can readily incorporate other clustering techniques and can be efficiently applied to data with high cardinality.

Systems and methods according to some examples may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to, or from, a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, (e.g., a mobile telephone, a personal digital assistant (PDA), a tablet, a mobile viewing device, a mobile audio player, a Global Positioning System (GPS) receiver), to name just a few. Computer-readable media suitable for storing computer program instructions and data include all forms of nonvolatile memory, media and memory devices, including by way of example semiconductor memory devices (e.g., EPROM, EEPROM, and flash memory devices); magnetic disks (e.g., internal hard disks or removable disks; magneto optical disks; and CD ROM and DVD-ROM disks). The processor and the memory can be supplemented by, or incorporated in, special purpose logic circuitry.

The computer components, software modules, functions, data stores and data structures described herein may be connected directly or indirectly to each other in order to allow the flow of data needed for their operations. It is also noted that a module or processor includes, but is not limited to, a unit of code that performs a software operation, and can be implemented, for example, as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products (i.e., one or more modules of computer program instructions encoded on a computer-readable medium for execution by, or to control the operation of, data processing apparatus). The computer-readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question (e.g., code that constitutes processor firmware, a protocol stack, a graphical system, a database management system, an operating system, or a combination of one or more of them).

While this disclosure may contain many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be utilized. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop®, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score. Some systems may use SAS In-Memory Statistics for Hadoop® to read big data once and analyze it several times by persisting it in-memory for the entire session.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-program product tangibly embodied in a non-transitory machine-readable storage medium, including instructions configured to be executed to cause a data processing apparatus to:
receive input data related to a decision tree to be generated from a data set, wherein the input data identifies a target attribute of the data set and a set of candidate attributes of the data set to be used as nodes in the decision tree;
determine, using a clustering algorithm and the set of candidate attributes, a plurality of potential splitting schemes to be used to split a node in the decision tree;
calculate a splitting measurement for each of the plurality of potential splitting schemes; and
select an optimal splitting scheme from the plurality of potential splitting schemes for each node in the decision tree based on the splitting measurement.

2. The computer-program product of claim 1, wherein the instructions are further configured to be executed to cause the data processing apparatus to generate the decision tree according to the selected optimal splitting scheme.

3. The computer-program product of claim 1, wherein the selected splitting scheme is associated with a highest splitting measurement of the plurality of potential splitting schemes.

4. The computer-program product of claim 1, wherein the target attribute is an attribute of the data set that is designated as a leaf node of the decision tree.

5. The computer-program product of claim 1, wherein a splitting scheme of the plurality of potential splitting schemes identifies a number of branches to be split from the node and an arrangement of branches to be split from the node.

6. The computer-program product of claim 1, wherein the input data further includes a maximum number of branches.

7. The computer-program product of claim 1, wherein the instructions that are configured to determine, using the clustering algorithm and the set of candidate attributes, the plurality of potential splitting schemes for each node in the decision tree are further configured to be executed to cause the data processing apparatus to:
calculate, using the clustering algorithm, a number of cluster combinations for each candidate attribute of the set of candidate attributes, wherein the number of cluster combinations is based on a maximum number of branches;
score the number of cluster combinations for each candidate attribute based on a measure of statistical dispersion; and
select, for each candidate attribute, a cluster combination based on the score.

8. The computer-program product of claim 7, wherein the measure of statistical dispersion is scored using one of an entropy function, an impurity function, or an information gain ratio.

9. A computer-implemented method, comprising:
receiving, by a computing device, input data related to a decision tree to be generated from a data set, wherein the input data identifies a target attribute of the data set and a set of candidate attributes of the data set to be used as nodes in the decision tree;
determining, by the computing device, using a clustering algorithm and the set of candidate attributes, a plurality of potential splitting schemes to be used to split a node in the decision tree;
calculating, by the computing device, a splitting measurement for each of the plurality of potential splitting schemes; and
selecting, by the computing device, an optimal splitting scheme from the plurality of potential splitting schemes for each node in the decision tree based on the splitting measurement.

10. The computer-implemented method of claim 9, further comprising generating, by the computing device, the decision tree according to the selected splitting scheme.

11. The computer-implemented method of claim 9, wherein the selected splitting scheme is associated with a highest splitting measurement of the plurality of potential splitting schemes.

12. The computer-implemented method of claim 9, wherein the target attribute is an attribute of the data set that is designated as a leaf node of the decision tree.

13. The computer-implemented method of claim 9, wherein a splitting scheme of the plurality of potential spitting schemes identifies a number of branches to be split from the node and an arrangement of branches to be split from the node.

14. The computer-implemented method of claim 9, wherein the input data further includes a maximum number of branches.

15. The computer-implemented method of claim 9, wherein determining by the computing device, using the clustering algorithm and the set of candidate attributes, the plurality of potential splitting schemes for each node in the decision tree further comprises:
calculating, using the clustering algorithm, a number of cluster combinations for each candidate attribute of the set of candidate attributes, wherein the number of cluster combinations is based on a maximum number of branches;
scoring the number of cluster combinations for each candidate attribute based on a measure of statistical dispersion; and
selecting, for each candidate attribute, a cluster combination of the number of cluster combinations based on the score.

16. The computer-implemented method of claim 15, wherein the measure of statistical dispersion is scored using one of an entropy function, an impurity function, or an information gain ratio.

17. A system, comprising:
a processor; and
a non-transitory computer-readable storage medium including instructions configured to be executed that, when executed by the processor, cause the system to perform operations including:
receiving input data related to a decision tree to be generated from a data set, wherein the input data identifies a target attribute of the data set and a set of candidate attributes of the data set to be used as nodes in the decision tree;
determining using a clustering algorithm and the set of candidate attributes, a plurality of potential splitting schemes to be used to split a node in the decision tree;
calculating a splitting measurement for each of the plurality of potential splitting schemes; and
selecting an optimal splitting scheme from the plurality of potential splitting schemes for each node in the decision tree based on the splitting measurement.

18. The system of claim 17, including further instructions configured to be executed that, when executed by the processor, cause the system to perform further operations including generating the decision tree according to the selected splitting scheme.

19. The system of claim 17, wherein the selected splitting scheme is associated with a highest splitting measurement of the plurality of potential splitting schemes.

20. The system of claim 17, wherein the target attribute is an attribute of the data set that is designated as a leaf node of the decision tree.

21. The system of claim 17, wherein a splitting scheme of the plurality of potential splitting schemes identifies a number of branches to be split from the node and an arrangement of branches to be split from the node.

22. The system of claim 17, wherein the input data further includes a maximum number of branches.

23. The system of claim 17, wherein the instructions that are, when executed by the processor, configured to determine, using the clustering algorithm and the set of candidate attributes, the plurality of splitting schemes for each node in the decision tree, include further instructions that are configured to, when executed by the processor, cause the system to perform operations including:
calculating, using the clustering algorithm, a number of cluster combinations for each candidate attribute of the set of candidate attributes, wherein the number of cluster combinations is based on a maximum number of branches;
scoring the number of cluster combinations for each candidate attribute based on a measure of statistical dispersion; and
selecting, for each candidate attribute, a cluster combination of the number of cluster combinations based on the score.

24. The system of claim 23, wherein the measure of statistical dispersion is scored using one of an entropy function, an impurity function, or an information gain ratio.
